(19) United States
(12) Patent Application Publication
(10) Pub. No.: US 2016/0140242 A1
(43) Pub. Date: May 19, 2016

(54) MULTI-DIRECTIONAL SEARCH

(71) Applicant: Panton Incorporated, Houston, TX (US)

(72) Inventor: Saishi Frank LI, Sugar Land, TX (US)

(21) Appl. No.: 14/546,222

(22) Filed: Nov. 18, 2014

(51) Int. Cl. G06F 17/30

(52) U.S. Cl. CPC G06F 17/30867

(57) ABSTRACT

Methods for providing a multi-directional search using an electronic computing device are presented, the method including: causing the electronic computing device to provide a multi-directional search bar; displaying a number of audience selections to whom the multi-directional search is directed; selecting any of the number of audience selections; entering a multi-directional search query; and returning a response to the multi-directional search query based on both the selected audience and the search query. In some embodiments, methods further include: providing a number of privacy settings corresponding with the selected audience selection; and selecting one of the number of privacy settings, where the selected privacy setting is selected from the group consisting of: a private search and a public search.

### BACKGROUND

Conventional search technology represents greatly expanded human information and “intelligence.” Humans no longer need to retain vast amounts of knowledge as they can simply search the Internet to find the results they are looking for. Individuals utilizing such technology may now be very well-informed and be considered “Smart People.” Conventional search technologies execute searches on open repositories having data that may be mined for a variety of purposes. When a search is performed on a data store, any number of results may be returned based on terminology parsing or execution strategies. However, results remain necessarily passive. That is, data must already exist for a search to be performed and a result to be returned. If the data does not exist, no result may be achieved.

In order to fill this gap, there may be websites that utilize an inquiry/response transaction. That is, a user may make a request for specific information that will then be answered by personnel associated with a particular system. However these systems rely on a third party's access rather than the user's access. As such, results from inquiry/response transactions may have limited utility. As such, multi-directional searches are provided herein.

### SUMMARY

The following presents a simplified summary of some embodiments of the invention in order to provide a basic understanding of the invention. This summary is not an extensive overview of the invention. It is not intended to identify key/critical elements of the invention or to delineate the scope of the invention. Its sole purpose is to present some embodiments of the invention in a simplified form as a prelude to the more detailed description that is presented below.

Methods for providing a multi-directional search using an electronic computing device are presented, the method including: causing the electronic computing device to provide a multi-directional search bar; displaying a number of audience selections to whom the multi-directional search is directed; selecting any of the number of audience selections; entering a multi-directional search query; and returning a response to the multi-directional search query based on both the selected audience and the search query. In some embodiments, methods further include: providing a number of privacy settings corresponding with the selected audience selection; and selecting one of the number of privacy settings, where the selected privacy setting is selected from the group consisting of: a private search and a public search. In some embodiments, a user selecting any of the number of audience selections selects an audience from the group consisting of: an individual audience, a workgroup audience, a company internal audience, a company external audience, a company related audience, and an open audience. In some embodiments, the user does not select any of the number of audience selections, a default audience is selected. In some embodiments, returning a response further includes: searching a previous search repository; searching an audience repository corresponding with a selected audience; and posting the multi-directional search query to the selected audience. In some embodiments, posting the multi-directional search query to the selected audience further includes: posting a number of times the search query has been made to the selected audience; and posting a type of people making the search query to the selected audience. In some embodiments, methods further include: returning an audience response to the user in response to the posting the multi-directional search query to the selected audience. In some embodiments, when the user does not select any of the number of audience selections, selecting the audience based on the multi-directional search query. In some embodiments, methods further include: filtering the audience based on a user criterion. In some embodiments, the user criterion is selected from the group consisting of: a user access level, a user security clearance, a user job title, a user terminal, a user login identification, a user classification, a user project assignment, a user workgroup membership, and a user company membership.

In other embodiments, computing device program products for providing a multi-directional search using a computing device are presented, the computing device program products including: a non-transitory computer readable medium; first programmatic instructions for causing the electronic computing device to provide a multi-directional search bar; second programmatic instructions for displaying a number of audience selections to whom the multi-directional search is directed; third programmatic instructions for selecting any of the number of audience selections; fourth programmatic instructions for entering a multi-directional search query; and fifth programmatic instructions for returning a response to the multi-directional search query based on both the selected audience and the search query, where the programmatic instructions are stored on the non-transitory computer readable medium. In some embodiments, methods further include: sixth programmatic instructions for providing a number of privacy settings corresponding with the selected audience selection; and seventh programmatic instructions for selecting one of the number of privacy settings, where the selected privacy setting is selected from the group consisting of: a private search and a public search. In some embodiments, when the user does not select any of the number of audience selections, a default audience is selected. In some embodiments, methods further include: eighth programmatic instructions for searching a previous search repository; ninth programmatic instructions for searching an audience repository corresponding with a selected audience; and tenth programmatic instructions for posting the multi-directional search query to the selected audience.

In other embodiments, systems of computer hardware having a processor for providing a multi-directional search are presented, the systems including: causing the computer hardware device to provide a multi-directional search bar; displaying a number of audience selections to whom the multi-directional search is directed; selecting any of the number of audience selections; providing a number of privacy settings corresponding with the selected audience selection; selecting one of the number of privacy settings, where the selected privacy setting is selected from the group consisting of: a private search and a public search; entering a multi-directional search query; searching a previous search repository; searching an audience repository corresponding with a selected audience; posting the multi-directional search query to the selected audience; and returning a response to the multi-directional search query based on both the selected audience and the search query.

### BRIEF DESCRIPTION OF THE DRAWINGS

The present invention is illustrated by way of example, and not by way of limitation, in the figures of the accompanying drawings and in which like reference numerals refer to similar elements and in which:

FIG. 1 is an illustrative representation of environments in which multidirectional search methods may be utilized in accordance with embodiments of the present invention;

FIG. 2 is a illustrative flowchart of methods for providing a multi-directional search interface in accordance with embodiments of the present invention;

FIG. 3 is a illustrative flowchart of methods for providing a multi-directional search in accordance with embodiments of the present invention; and

FIG. 4 is a illustrative flowchart of methods for providing a multi-directional search in accordance with embodiments of the present invention.

### DETAILED DESCRIPTION

The present invention will now be described in detail with reference to a few embodiments thereof as illustrated in the accompanying drawings. In the following description, numerous specific details are set forth in order to provide a thorough understanding of the present invention. It will be apparent, however, to one skilled in the art, that the present invention may be practiced without some or all of these specific details. In other instances, well known process steps and/or structures have not been described in detail in order to not unnecessarily obscure the present invention.

As will be appreciated by one skilled in the art, the present invention may be a system, a method, and/or a computer program product. The computer program product may include a computer readable storage medium (or media) having computer readable program instructions thereon for causing a processor to carry out aspects of the present invention. The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing.

A computer readable storage medium, as used herein, is not to be construed as being transitory signals /per se/, such as radio waves or other freely propagating electromagnetic waves, electromagnetic waves propagating through a waveguide or other transmission media (e.g., light pulses passing through a fiber-optic cable), or electrical signals transmitted through a wire. Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device. Computer readable program instructions for carrying out operations of the present invention may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions. These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks. The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks. The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

The computer program instructions may also be loaded onto a computer or other programmable data processing apparatus to cause a series of operational steps to be performed on the computer or other programmable apparatus to produce a computer implemented process such that the instructions which execute on the computer or other programmable apparatus provide processes for implementing the functions/acts specified in the flowchart and/or block diagram block or blocks.

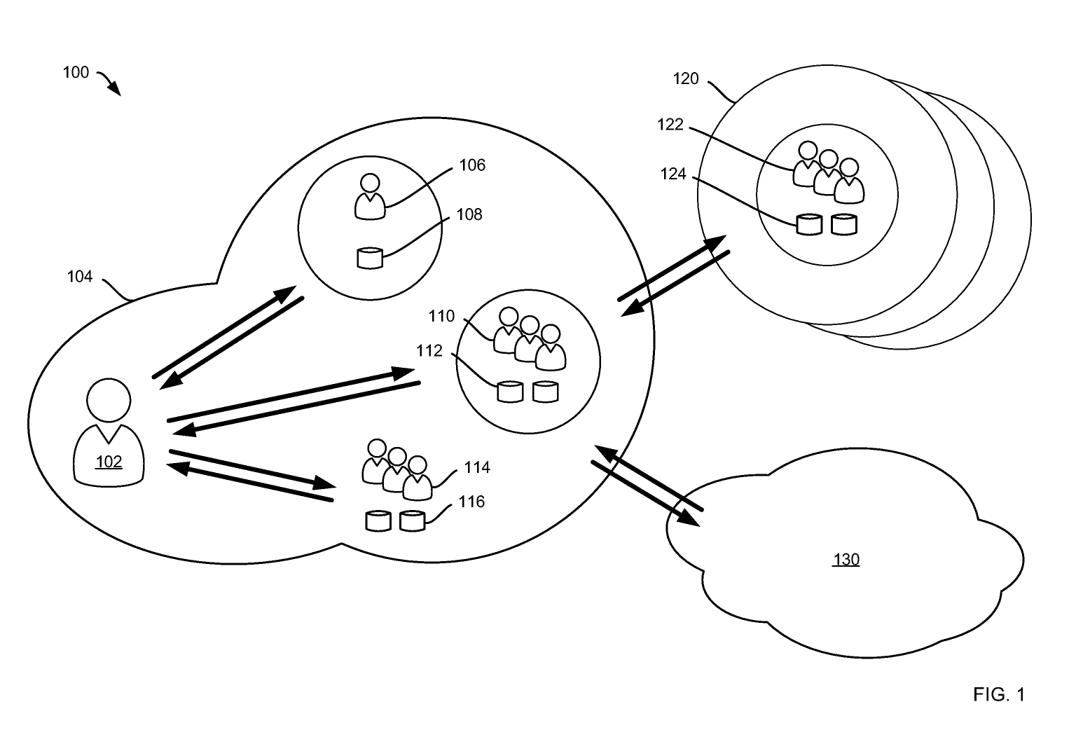

FIG. 1 is an illustrative representation 100 of environments in which multidirectional search methods may be utilized in accordance with embodiments of the present invention. As illustrated, user 102 utilizing method embodiments provided herein may execute a multi-directional search that may reach a variety of audiences. For example user 102 in company network 104 may execute a private search directed to individual 106 and corresponding repository 108. Further illustrated, user 102 may execute a private search directed to group 110 and corresponding repository 112. Still further illustrated, user 102 may execute a public search directed to individuals or group 114 and corresponding repository 116. Utilizing method embodiments herein, a search may be posted to any number of individuals or groups or repositories. A repository may be any searchable data store without limitation and without departing from embodiments herein. In some embodiments, previous searches may be stored in a repository thus building a knowledge base. In this manner, a user may search at least, individuals or groups; repositories associated with individuals or groups; and previous searches.

It may be noted that company network 104 is illustrated to represent a defined network. However, a group may be defined in any manner. For example, groups may be defined by platform integration, by interest group, by geographic location, or by any other suitable designation known in the art without departing from embodiments provided herein. As such, as illustrated, user 102 may execute a private search outside of company 104 to another company 120 having users 122 and corresponding repositories 124. Still further, user 102 may execute a public search to public network 130 and may search any number of corresponding repositories. It may be appreciated that any number of variations may contemplated utilizing embodiments provided herein.

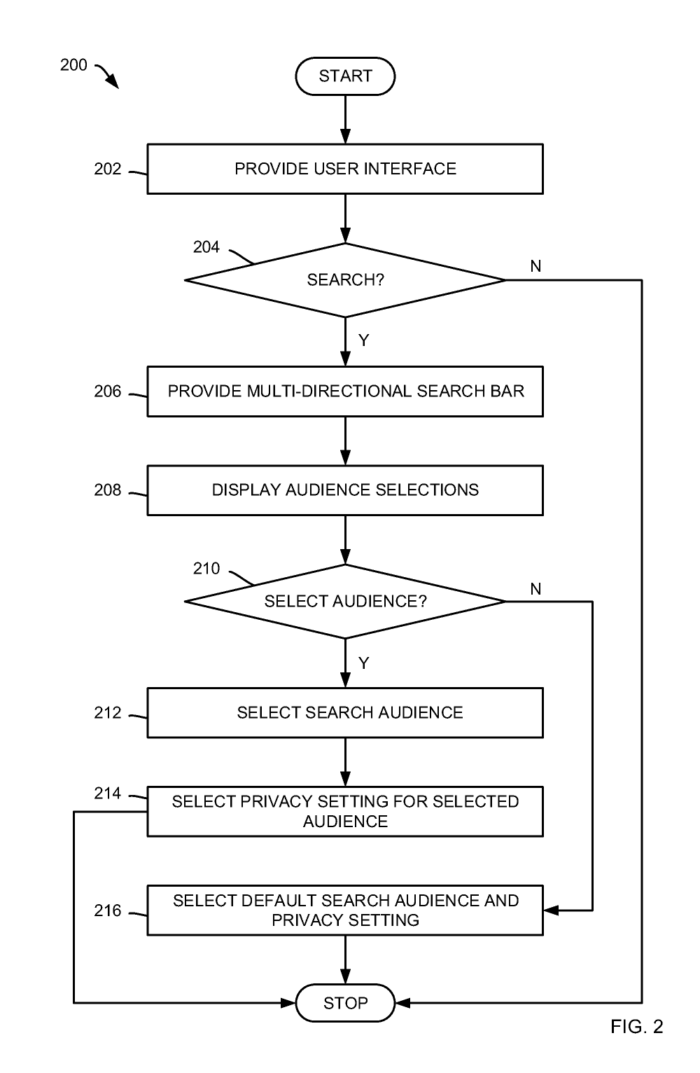

FIG. 2 is a illustrative flowchart 200 of methods for providing a multi-directional search interface in accordance with embodiments of the present invention. At a first step 202, the method provides a user interface for executing a multi-directional search. As may be appreciated, a user interface may be implemented in a variety of ways. It is intended that the methods provided herein may be accomplished over any user interface that provides the required selections as set forth herein without limitation and without departing from embodiments herein. At a next step 204, the method determines whether to execute a search. If the method determines at a step 204 not to execute a search, the method ends. If the method determines at a step 204 to execute a search, the method continues to a step 206 to provide a multi-directional search bar. A multi-directional search bar may include any number of selections. For example, at a step 208, the method may display a number of audience selections to whom a multi-directional search may be directed. In embodiments, audiences may include an individual audience, a workgroup audience, a company internal audience, a company external audience, a company related audience, and an open audience. An audience, as contemplated herein, is an individual or group to whom a search may be directed. That is, in conventional searches, a search may be executed on searchable repositories over a network or over the Internet for example. In a multi-directional search, searches may be further directed to include a selected audience, a repository corresponding with a selected audience, and a repository of previous searches. In this manner, a search may be directed to an individual or group that may more effectively respond to a search query.

At a next step 210, the method determines whether to select an audience. If the method determines at a step 210 not to select an audience, the method continues to a step 216 to select a default audience and privacy setting. If the method determines at a step 210 to select an audience, the method continues to a step 212 to select an audience. In embodiments, a user may decide to select an audience or not to select an audience. In an example where a user decides not to select an audience, the method may select a default audience and privacy settings. In an example where a user decides to select an audience, a user may select any of a number of audiences including: an individual audience, a workgroup audience, a company internal audience, a company external audience, a company related audience, and an open audience. Audiences may be defined in any manner known in the art without limitation and without departing from embodiments provided herein. In embodiments, audiences may be defined as follows:

An individual audience may be directed to a single individual, including the user executing the search, within a company network or platform;

A workgroup audience may be directed to a group of individuals defined by a project or functional workgroup within a company network or platform;

A company external audience may be directed to individuals or groups that are outside of a company network or platform;

A company related audience may be directed to individuals or groups that are related in some way to on-going company affairs outside a company network or platform; and

An open audience may be directed to individuals or groups that are within a company network or platform, outside a company network or platform, or both.

At a next step 214, the method selects a privacy setting for a selected audience. Privacy settings may include a private search and a public search. As noted above, searches and search results may be stored and made available to others in order to increase the knowledge leverage of those participating in multi-directional searches. A public search setting allows such functionality. However, in some examples, a user may not wish to make the search or the results public. In that example, a private search make the search and search results available only to the user. In other examples, privacy settings may be automatically established upon selection of an audience. As such, privacy for an audience may be controlled uniformly across a company. In this manner, sensitive searches may be confidentially maintained. The method then ends. It may be noted at a step 216, that selection of default search audience and privacy setting may be accomplished in a number of different manners. For example, defaults may be based on the user. For example, a user having a low-level clearance may include default settings that do not allow particular types of searches, such as searches on confidential and proprietary information. As such, a user criterion may be utilized to select default settings such as, for example, user access level, a user security clearance, a user job title, a user terminal, a user login identification, a user classification, a user project assignment, a user workgroup membership, and a user company membership.

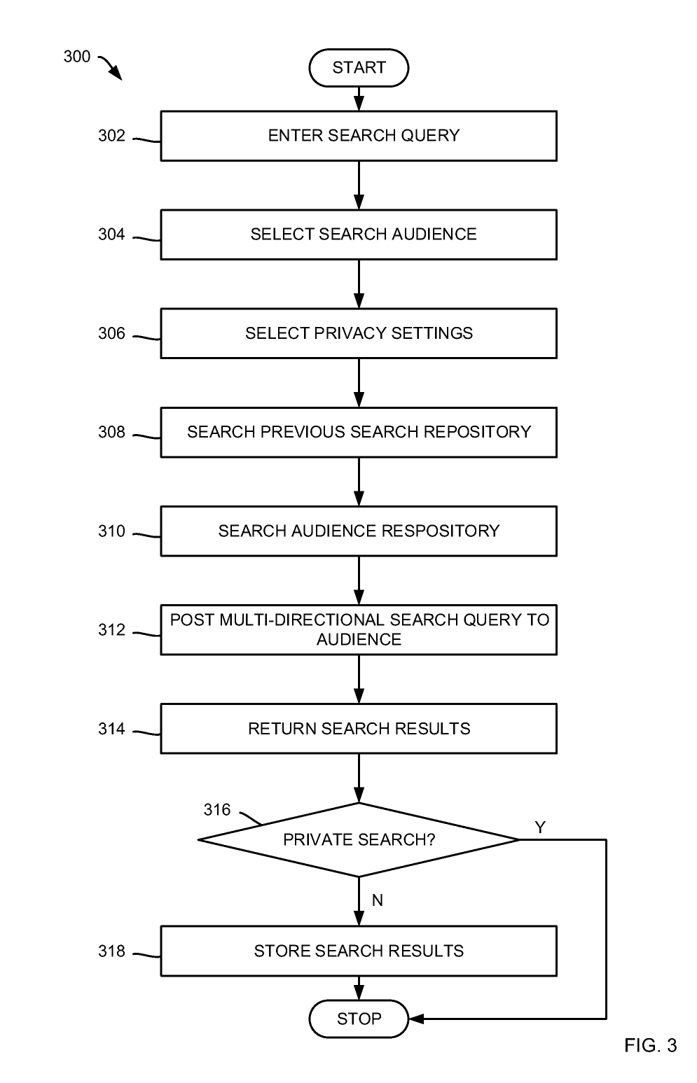

FIG. 3 is a illustrative flowchart 300 of methods for providing a multi-directional search in accordance with embodiments of the present invention. At a first step 302, the method enters a search query. As such, a user may enter any search query format known in the art without departing from embodiments provided herein. At a step 304, the method selects an audience. In embodiments, a user may select any number of audiences such as: an individual audience, a workgroup audience, a company internal audience, a company external audience, a company related audience, and an open audience. In some embodiments, audiences are provided by way of a drop down menu, however, audiences may be presented in any manner known in the art. In other embodiments, an audience may be selected based on the search query. That is, when a user enters a search query, terms in the search query may be utilized to direct the search query to pre-determined individuals or group. For example, a search query having the term “budget” may be automatically directed to an accounting workgroup.

At a next step 306, the method selects a privacy setting corresponding with a selected audience. As noted above, searches and search results may be stored and made available to others in order to increase the knowledge leverage of those participating in multi-directional searches. A public search setting allows such functionality. However, in some examples, a user may not wish to make the search or the results public. In that example, a private search make the search and search results available only to the user. In other examples, privacy settings may be automatically established upon selection of an audience. As such, privacy for an audience may be controlled uniformly across a company. In this manner, sensitive searches may be confidentially maintained or, in other examples, transparency may be achieved.

At a next step 308, the method searches a previous search repository. Searching a previous search repository may provide a more rapid response to a common search. As such, a knowledge base may be formed that is more effectively responsive to a user. At a next step 310, the method searches an audience repository corresponding with a selected audience. It may be appreciated that an audience repository may include any type or number of data stores such as, for example, a local data store, a local database, a cloud-based data store, a cloud-based database, and the like—all of which correspond with the audience. That is, data stores may be “owned” by an audience or may be associated with an audience such that the search is directed to data that is relevant to the audience. At a next step 312, the method posts the multi-directional search query to the audience. Posting a multi-directional search query to an audience may provide a more dynamic search result to a user since responses to the query will be current. In addition, posting a multi-directional search query to an audience may further include, posting the number of times a search query has been made to the selected audience; and posting a type of people making a search query to the selected audience. These additional features may provide additional metrics for users as well as audience members. For example, posting the number of times a search query has been made to the selected audience may provide insight into the importance of the information being sought. In addition, posting a type of people making the search query may provide insight into which information is important to which group of people thus potentially identifying a training need for a particular group.

At a next step 314, the method returns the results of the multi-directional search query. In particular, results from steps 308, 310, and 312 may be returned. In some embodiments, search results from a step 312 may be delayed as audience responses may not be made immediately. In those cases, the method forwards search results as they come available. At a next step 316, the method determines whether the search is private. If the method determines at a step 316 that the search is private, the method ends. If the method determines at a step 316 that the search is not private (i.e. public), the method continues to a step 318 to store the results of the search to a previous search repository. The method then ends.

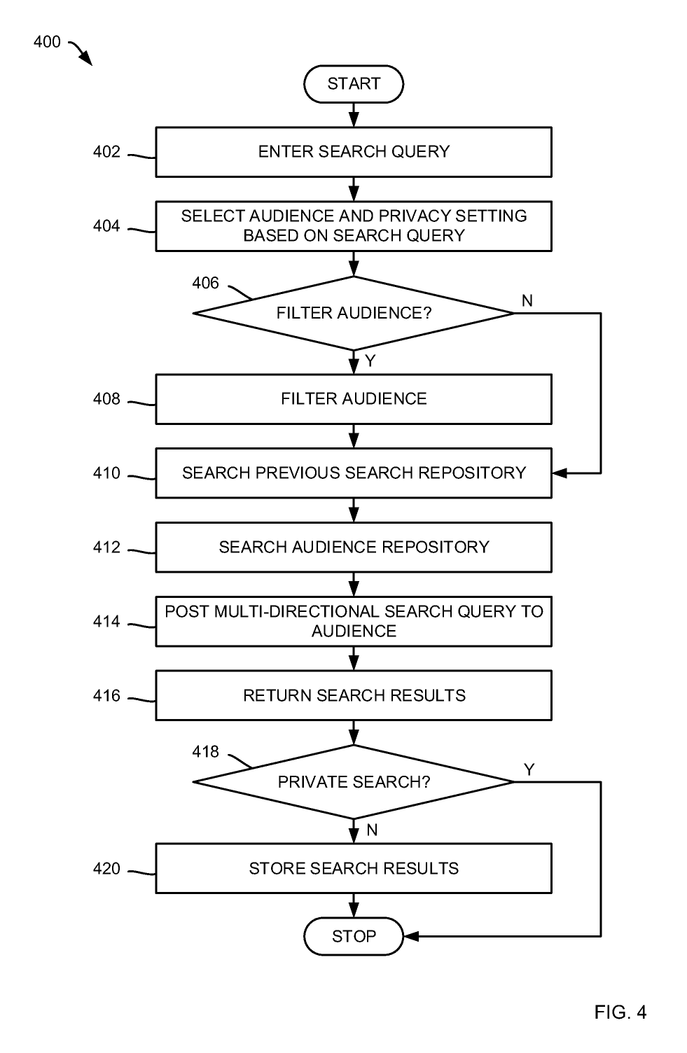

FIG. 4 is a illustrative flowchart of methods for providing a multi-directional search in accordance with embodiments of the present invention. In particular, FIG. 4 illustrates some automated functions of methods provided herein. At a first step 402, the method enters a search query. As such, a user may enter any search query format known in the art without departing from embodiments provided herein. At a next step 404, the method selects an audience and privacy setting based on the search query. That is, when a user enters a search query, terms in the search query may be utilized to direct the search query to pre-determined individuals or group. For example, a search query having the term “budget” may be automatically directed to an accounting workgroup with a privacy setting of “private.” In some embodiments, automated selection of an audience may be accompanied by an audience filter. That is, it may be useful to limit the audience selected based on a user criterion. As such, at a next step 406, the method determines whether to filter the selected audience. If the method determines at a step 406 not to filter an audience, the method continues to a step 410. If the method determines at a step 406 to filter an audience, the method continues to a step 408 to filter the audience. In embodiments, filtering an audience may be based on a user criterion such as, for example, a user access level, a user security clearance, a user job title, a user terminal, a user login identification, a user classification, a user project assignment, a user workgroup membership, and a user company membership. In this manner, audiences may be limited to a user's specific requirement and classification.

At a next step 410, the method searches a previous search repository. Searching a previous search repository may provide a more rapid response to a common search. As such, a knowledge base may be formed that is more effectively responsive to a user. At a next step 412, the method searches an audience repository corresponding with a selected audience. It may be appreciated that an audience repository may include any type or number of data stores such as, for example, a local data store, a local database, a cloud-based data store, a cloud-based database, and the like—all of which correspond with the audience. That is, data stores may be “owned” by an audience or may be associated with an audience such that the search is directed to data that is relevant to the audience. At a next step 414, the method posts the multi-directional search query to the audience. Posting a multi-directional search query to an audience may provide a more dynamic search result to a user since responses to the query will be current. In addition, posting a multi-directional search query to an audience may further include, posting the number of times a search query has been made to the selected audience; and posting a type of people making a search query to the selected audience. These additional features may provide additional metrics for users as well as audience members. For example, posting the number of times the search query has been made to the selected audience may provide insight into the importance of the information being sought. In addition, posting a type of people making the search query may provide insight into which information is important to which group of people thus potentially identifying a training need for a particular group.

At a next step 416, the method returns the results of the multi-directional search query. In particular, results from steps 410, 412, and 414 may be returned. In some embodiments, search results from a step 414 may be delayed as audience responses may not be made immediately. In those cases, the method forwards search results as they come available. At a next step 418, the method determines whether the search is private. If the method determines at a step 418 that the search is private, the method ends. If the method determines at a step 418 that the search is not private (i.e. public), the method continues to a step 420 to store the results of the search to a previous search repository. The method then ends.

While this invention has been described in terms of several embodiments, there are alterations, permutations, and equivalents, which fall within the scope of this invention. It should also be noted that there are many alternative ways of implementing the methods and apparatuses of the present invention. Furthermore, unless explicitly stated, any method embodiments described herein are not constrained to a particular order or sequence. Further, the Abstract is provided herein for convenience and should not be employed to construe or limit the overall invention, which is expressed in the claims. It is therefore intended that the following appended claims be interpreted as including all such alterations, permutations, and equivalents as fall within the true spirit and scope of the present invention.

What is claimed is:

1. A method for providing a multi-directional search using an electronic computing device, the method comprising:
causing the electronic computing device to provide a multi-directional search bar;
displaying a plurality of audience selections to whom the multi-directional search is directed;
selecting any of the plurality of audience selections;
entering a multi-directional search query; and
returning a response to the multi-directional search query based on both the selected audience and the search query.

2. The method of claim 1, further comprising:
providing a plurality of privacy settings corresponding with the selected audience selection; and
selecting one of the plurality of privacy settings, wherein the selected privacy setting is selected from the group consisting of: a private search and a public search.

3. The method of claim 1, wherein a user selecting any of the plurality of audience selections selects an audience from the group consisting of: an individual audience, a workgroup audience, a company internal audience, a company external audience, a company related audience, and an open audience.

4. The method of claim 1 wherein when the user does not select any of the plurality of audience selections, a default audience is selected.

5. The method of claim 1, wherein returning a response further comprises:
searching a previous search repository;
searching an audience repository corresponding with a selected audience; and
posting the multi-directional search query to the selected audience.

6. The method of claim 5, wherein posting the multi-directional search query to the selected audience further comprises:
posting a number of times the search query has been made to the selected audience; and
posting a type of people making the search query to the selected audience.

7. The method of claim 5, further comprising:
saving the multi-directional search to the previous search repository.

8. The method of claim 5 further comprising:
returning an audience response to the user in response to the posting the multi-directional search query to the selected audience.

9. The method of claim 8 further comprising:
adding the audience response to the previous search repository.

10. The method of claim 1, wherein when the user does not select any of the plurality of audience selections, selecting the audience based on the multi-directional search query.

11. The method of claim 10, further comprising:
filtering the audience based on a user criterion.

12. The method of claim 11, wherein the user criterion is selected from the group consisting of: a user access level, a user security clearance, a user job title, a user terminal, a user login identification, a user classification, a user project assignment, a user workgroup membership, and a user company membership.

13. A computing device program product for providing a multi-directional search using a computing device, the computing device program product comprising:
a non-transitory computer readable medium;
first programmatic instructions for causing the electronic computing device to provide a multi-directional search bar;
second programmatic instructions for displaying a plurality of audience selections to whom the multi-directional search is directed;
third programmatic instructions for selecting any of the plurality of audience selections;
fourth programmatic instructions for entering a multi-directional search query; and
fifth programmatic instructions for returning a response to the multi-directional search query based on both the selected audience and the search query, wherein the programmatic instructions are stored on the non-transitory computer readable medium.

14. The computing device program product of claim 13, further comprising:
sixth programmatic instructions for providing a plurality of privacy settings corresponding with the selected audience selection; and
seventh programmatic instructions for selecting one of the plurality of privacy settings, wherein the selected privacy setting is selected from the group consisting of: a private search and a public search.

15. The computing device program product of claim 13, wherein a user selecting any of the plurality of audience selections selects an audience from the group consisting of: an individual audience, a workgroup audience, a company internal audience, a company external audience, a company related audience, and an open audience.

16. The computing device program product of claim 13 wherein when the user does not select any of the plurality of audience selections, a default audience is selected.

17. The computing device program product of claim 13, wherein returning a response further comprises:
eighth programmatic instructions for searching a previous search repository;
ninth programmatic instructions for searching an audience repository corresponding with a selected audience; and
tenth programmatic instructions for posting the multi-directional search query to the selected audience.

18. The computing device program product of claim 17, wherein posting the multi-directional search query to the selected audience further comprises:
eleventh programmatic instructions for posting a number of times the search query has been made to the selected audience;
twelfth programmatic instructions for posting a type of people making the search query to the selected audience; and
thirteenth programmatic instructions for returning an audience response to the user in response to the posting the multi-directional search query to the selected audience.

19. The computing device program product of claim 13, wherein when the user does not select any of the plurality of audience selections, fourteenth programmatic instructions for selecting the audience based on the multi-directional search query.

20. A system of computer hardware having a processor for providing a multi-directional search, the system comprising:
causing the computer hardware device to provide a multi-directional search bar;
displaying a plurality of audience selections to whom the multi-directional search is directed;
selecting any of the plurality of audience selections;
providing a plurality of privacy settings corresponding with the selected audience selection;
selecting one of the plurality of privacy settings, wherein the selected privacy setting is selected from the group consisting of: a private search and a public search;
entering a multi-directional search query;
searching a previous search repository;
searching an audience repository corresponding with a selected audience;
posting the multi-directional search query to the selected audience; and
returning a response to the multi-directional search query based on both the selected audience and the search query.
